(19) United States
(12) Patent Application Publication
(10) Pub. No.: US 2019/0075804 A1
(43) Pub. Date: Mar. 14, 2019

(54) EDIBLE FAT PRODUCT

(71) Applicant: BALKAN PASTRY LTD 1988, Yavne (IL)

(72) Inventors: Noam BABILA, Nes Ziona (IL); Danny DIZER, Rishon LeZion (IL); Tal LEIZER, Zikhron Yaacov (IL)

(21) Appl. No.: 16/084,621

(22) PCT Filed: Mar. 14, 2017
(86) PCT No.: PCT/IL2017/050322

§ 371 Date: Sep. 13, 2018

Related U.S. Application Data
(60) Provisional application No. 62/307,598, filed on Mar. 14, 2016.

(51) Int. Cl. A21D 13/068; A21D 2/14; A21D 2/16; A23D 7/01

(52) U.S. Cl. CPC A21D 13/068; A21D 2/145; A23D 7/005; A23D 7/01; A21D 2/165

(57) ABSTRACT

The subject matter discloses an edible fat composition, comprising fat component, a protein component comprising milk protein and fiber. The protein component comprises milk caseins and may be milk, yogurt, cream and others.

### FIELD OF THE INVENTION

The present invention generally relates to the field of edible food products, and more specifically to an edible fat product.

### BACKGROUND OF THE INVENTION

Edible fat food products may be used for pastries, sauces, soups, frying and the like. Such fat may be made of oil, margarine, butter, and the like. Hence, the fat product is about 80-100 percent fat, with a high percentage of saturated fat, cholesterol and calories. When cooking and baking using fat, the overall fat percentage may be significant, for example in the range of 15-30 by weight percentage.

Thus, there is a need to use a fat product having the qualities of fat and butter, with significantly less calories and cholesterol.

### SUMMARY OF THE INVENTION

The subject matter discloses an edible fat composition, comprising fat component, a protein component comprising milk protein of at least about 5% by weight of the protein component and fiber.

In some cases, the edible fat composition further comprises cocoa butter. In some cases, the edible fat composition further comprises humectants. In some cases, the humectants comprise glycerin. In some cases, the humectants is present in the composition in an amount of between about 0.4% to about 5% by weight of the composition.

In some cases, the edible fat composition further comprises an emulsifier. In some cases, the emulsifier is present in the composition in an amount of between about 0.1% to about 2% by weight of the composition. In some cases, the emulsifier is selected from a group consisting of sucrose ester, lecithin, an ester of monoglycerides of fatty acids, monoglycerides of fatty acids, and diglycerides of fatty acid.

In some cases, the edible fat composition further comprises flavor enhancers of about 0.1-1% by weight of the composition. In some cases, the flavor enhancers comprise at least one of butter buds, concentrate of butter fatty acid and aroma components. In some cases, the flavor enhancers are present in the composition in an amount of between about 0.1% to about 2% by weight of the composition.

In some cases, the protein component is selected from a group consisting of yogurt, cheese, cream, sour cream, milk and a combination thereof. In some cases, the protein component comprises casein. In some cases, the protein component is present in the composition in an amount of between about 15% to about 30% by weight of the composition. In some exemplary cases, the protein component is yogurt and comprises milk caseins at about 8%-10% by weight of the protein component and/or starch.

In some cases, the fat is selected from a group consisting of butter, margarine, coconut oil and a combination thereof. In some cases, the fiber is a plant derived fiber. In some cases, the fiber is present in the composition in an amount of between about 0.1% to about 2% by weight of the composition.

In some cases, the fat composition has a margarine-like texture in a temperature range of 10-30 degrees Celsius. In some cases, the fiber binds the fat and the milk product in a manner that enables liquid release when heating the composition.

The fat composition has to be stored at frozen temperature to keep it from bacterial spoilage.

### DETAILED DESCRIPTION OF THE INVENTION

The present invention discloses an edible fat composition having the qualities of a known fat such as margarine, butter and the like, with significantly less fat percentage. The fat composition may be used for seasoning, baking and cooking in general, and provides the same results with much better nutritional values since the composition comprises proteins and fibers. In some cases, the fat composition may be used when baking a pastry, either in a factory or at home, and reduce the pastry's fat level. The fat composition of the invention is solid at room temperature and liquid when heated. Thus, it provides a healthier substitute to margarine and butter.

The fat compositions of the invention advantageously present the following attributes:

1. About 30-40 percent less fat than margarine and butter.

2. Significantly less saturated fat than margarine and butter.

3. Proteins as an integral part of the fat composition.

The fat composition of the present invention comprises a fat component, such as margarine or butter, a protein component and a fiber component for binding the fat and the protein components.

The fat component may be in solid state at temperature of 10-25 degrees Celsius. In such a case, the fat component may be selected from butter, margarine, coconut oil, cocoa butter and a combination thereof. Additional fat products and materials may be used, as long as the fat component has at least 70% by weight of fat. In some other cases, the component may be in liquid state at temperature of 10-25 degrees Celsius. The In such a case, the fat component may be olive oil, canola oil, or any other plant derived oil being in liquid state at room temperature.

According to some embodiments, the fat component is present in the composition at about 60% to about 95% by weight of the composition, about 60% to about 90% by weight of the composition, about 60% to about 85% by weight of the composition, about 60% to about 80% by weight of the composition, about 60% to about 75% by weight of the composition, about 60% to about 70% by weight of the composition, about 65% to about 95% by weight of the composition, about 65% to about 90% by weight of the composition, about 65% to about 85% by weight of the composition, about 65% to about 80% by weight of the composition, about 65% to about 75% by weight of the composition, about 70% to about 95% by weight of the composition, about 70% to about 90% by weight of the composition, about 70% to about 85% by weight of the composition, about 75% to about 95% by weight of the composition, or about 80% to about 92% by weight of the composition. Each possibility represents a separate embodiment of the invention.

The protein component may be selected from a group consisting of yogurt, cheese, cream, sour cream, milk and a combination thereof. In some cases, at least about 5% by weight of the protein component is milk proteins. The milk proteins may comprise caseins. The protein component may be in solid state or liquid state at temperature of 10-25 degrees Celsius. In some other cases, the protein component may be in solid state at temperature of 10-25 degrees Celsius.

According to some embodiments, the protein component is present in the composition at about 2% to about 30% by weight of the composition, about 5% to about 30% by weight of the composition, about 5% to about 25% by weight of the composition, about 5% to about 15% by weight of the composition, about 12% to about 32% by weight of the composition, about 12% to about 25% by weight of the composition, or about 17% to about 30% by weight of the composition. Each possibility represents a separate embodiment of the invention. According to some embodiments, the protein component is present in the composition, in an amount the does not exceed about 30%, about 25%, about 20%, about 15%, about 10%, about 5%, about 3%, about 2% or about 1% by weight of the composition. Each possibility represents a separate embodiment of the invention.

The protein component comprise a milk protein. The milk proteins may include caseins or other milk proteins desired by a person skilled in the art. According to some embodiments, the milk protein is present in the protein component at about 2% to about 10% by weight of the protein component, about 4% to about 6% by weight of the protein component, about 5% to about 8% by weight of the protein component, about 5% to about 15% by weight of the protein component, or about 4.5% to about 20% by weight of the composition. Each possibility represents a separate embodiment of the invention.

The fiber is used to bind the protein component and the fat component. As used herein the term “fibers” is interchangeable with the term “fibers” or “dietary fibers”. Fibers are typically referred to as the indigestible portion of food derived from plants. Fibers according to some embodiments of the invention are soluble fibers. Soluble fibers absorb water to form a gel, and may be fermented by bacteria within the large intestine. Increasing the amount of soluble dietary fiber in the diet may increase the feeling of fullness, or satiety, and contribute to weight management. As used herein the term “source of fiber” means the source from which the fiber is obtained or derived, for example, an extract of the source of fiber (for example a certain plant) having a particular degree of purification. Typical fiber sources include oats, peas, beans, lentils, fruits such as apples, oats, potatoes and some green vegetables. Exemplary soluble fibers include, but are not limited to, corn dextrin (such as Nutriose® 06), oligofructose (such as Orafti® P95 or L95), inulin, cyclodextrin or a combination thereof. The fibers may be soluble fibers, insoluble fibers such as cellulose fibers, or a combination thereof. According to some embodiments, the fibers are prebiotic. The fiber may be a citrus fiber (CF). The expanded internal surface area allows citrus fibers to tightly bind large amounts of oil and water and replace synthetic ingredients such as stabilizers and complex gum systems. The citrus fibers reduce moisture migration during storage, use crystal formation and syneresis upon thawing. In some cases, the fat composition comprises two or more distinct fibers, or two or more different fiber types.

According to some embodiments, the fiber is present in the composition at about 0.1% to about 4% by weight of the composition, about 0.1% to about 3% by weight of the composition, about 0.2% to about 2% by weight of the composition, about 0.2% to about 1.5% by weight of the composition, about 0.5% to about 4% by weight of the composition, about 0.01% to about 3% by weight of the composition, or about 0.5% to about 2% by weight of the composition. Each possibility represents a separate embodiment of the invention. According to some embodiments, the fiber is present in the composition, in an amount the does not exceed about 3%, about 2%, about 1.5%, about 1% or about 0.5 by weight of the composition. Each possibility represents a separate embodiment of the invention.

In some cases, the fat composition of the present invention further comprises flavor enhancers. In some cases, the flavor enhancers comprise butter buds. In some embodiments, the flavor enhancers comprise butter extracts. In some cases, the flavor enhancers comprise plant derived flavors. According to some embodiments, the flavor enhancers are present in the composition at about 0.02% to about 1.5% by weight of the composition, about 0.5% to about 4% by weight of the composition, about 0.1% to about 0.8% by weight of the composition, or about 0.1% to about 1% by weight of the composition. Each possibility represents a separate embodiment of the invention.

In some cases, the fat composition of the present invention further comprises humectants. In some cases, the humectants comprise glycerin. In some embodiments, the humectants comprise honey. According to some embodiments, the humectants are present in the composition at about 0.02% to about 1.5% by weight of the composition, about 0.5% to about 4% by weight of the composition, about 0.1% to about 0.8% by weight of the composition, or about 0.1% to about 1% by weight of the composition. Each possibility represents a separate embodiment of the invention.

In some cases, the fat composition of the present invention further comprises an emulsifier. The emulsifier used may be natural or synthetic. The emulsifiers may comprise sucrose ester (such as Sisterna® PS750), lecithin, esters of monoglycerides of fatty acids, esters of diglycerides of fatty acids, egg yolk emulsifying agent lecithin, soy lecithin, calcium stearoyl dilaciate (CSL), polyglycerol ester (PGE), sorbitan ester (SOE), pg ester (PGME), monoglyceride (MG), acetylated monoglyceride (AMG), and lactylated monoglyceride (LMG). Each possibility represents a separate embodiment of the invention.

According to some embodiments, the emulsifier is present in the composition at about 0.02% to about 0.5% by weight of the composition, about 0.2% to about 1.3% by weight of the composition, about 0.4% to about 2.8% by weight of the composition, or about 0.1% to about 0.7% by weight of the composition. Each possibility represents a separate embodiment of the invention.

The fat composition may be required to be kept frozen because of the protein component.

In some cases, the fat composition comprises cocoa butter. In some cases, the fat composition comprises water.

### EXAMPLES

The invention will be described in greater detail by way of specific examples. The following examples are offered for illustrative purposes and are not intended to limit the invention in any manner Many variations will suggest themselves and are within the full intended scope. Those of skill in the art will readily recognize a variety of non-critical parameters which can be changed or modified to yield essentially the same results. The term ‘about’, as used herein, refers to ±10% of the stated numerical value.

TABLE I
A fat composition

| Ingredient | (w/w %) |
|---|---|
| A fat component | 54%-69% |
| A protein component | 30%-45% |
| fiber | 0.5%-1% |

TABLE II
A fat composition with emulsifier and cocoa butter

| Ingredient | (w/w %) |
|---|---|
| A fat component | 50%-65% |
| A protein component | 27%-41% |
| Cocoa butter | 6%-8% |
| fiber | 0.6%-1.2% |
| emulsifier | 0.5%-1% |

TABLE III
A fat composition with flavor enhancers and humectants

| Ingredient | (w/w %) |
|---|---|
| A fat component | 50%-63% |
| A protein component | 35%-48% |
| fiber | 0.3%-0.8% |
| flavor enhancers | 0.45% |
| humectants | 1%-1.2% |

Although exemplary embodiments and methods for use have been described in detail above, those skilled in the art will understand that many variations are possible without departing from the spirit and scope of the invention, which is limited only by the appended claims.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. An edible fat composition, comprising:
fat component;
a protein component comprising milk protein;
fiber.

2. The edible fat composition according to claim 1, further comprises cocoa butter.

3. The edible fat composition according to claim 1, further comprises humectants.

4. The edible fat composition according to claim 3, wherein the humectants comprise glycerin.

5. The edible fat composition according to claim 3, wherein the humectants is present in the composition in an amount of between about 0.4% to about 5% by weight of the composition.

6. The edible fat composition according to claim 1, further comprises an emulsifier.

7. The edible fat composition according to claim 6, wherein the emulsifier is present in the composition in an amount of between about 0.1% to about 2% by weight of the composition.

8. The edible fat composition according to claim 6, wherein the emulsifier is selected from a group consisting of sucrose ester, lecithin, an ester of monoglycerides of fatty acids, monoglycerides of fatty acids, and diglycerides of fatty acid.

9. The edible fat composition according to claim 1, further comprises flavor enhancers.

10. The edible fat composition according to claim 9, wherein the flavor enhancers comprise butter buds.

11. The edible fat composition according to claim 9, wherein the flavor or flavor enhancers are present in the composition in an amount of between about 0.1% to about 2% by weight of the composition.

12. The edible fat composition according to claim 1, wherein the protein component is selected from a group consisting of yogurt, cheese, cream, sour cream, milk, a milk protein powder, and a combination thereof.

13. The edible fat composition according to claim 1, wherein the milk protein comprises casein.

14. The edible fat composition according to claim 1, wherein the protein component is present in the composition in an amount of between about 15% to about 30% by weight of the composition or equivalent as milk protein in a powder form.

15. The edible fat composition according to claim 1, wherein the fat is selected from a group consisting of butter, margarine, coconut oil and a combination thereof.

16. The edible fat composition according to claim 1, wherein the fiber is a plant derived fiber.

17. The edible fat composition according to claim 1, wherein the fiber is present in the composition in an amount of between about 0.1% to about 2% by weight of the composition.

18. The edible fat composition according to claim 1, wherein the fat composition has a margarine-like texture in a temperature range of 10-30 degrees Celsius.

19. The edible fat composition according to claim 1, wherein the fiber binds the fat and the milk product in a manner that enables liquid release when heating the composition.
